(19) United States
(12) Patent Application Publication
(10) Pub. No.: US 2004/0255415 A1
(43) Pub. Date: Dec. 23, 2004

(54) Cable feeding device

(76) Inventor: Ralph Silva, Spring Valley, CA (US)

Correspondence Address: Steven W. Webb, 655 Second Street, Encinitas, CA, 92024, US

(21) Appl. No.: 10/600,716

(22) Filed: Jun. 23, 2003

(51) Int. Cl. B08B 9/047

(52) U.S. Cl. 15/104.33

(57) ABSTRACT

An invention is presented that guides plumbers snake cables into and out of snake cable machines, permitting the user to set the direction of snake travel and providing positive control of the snake cable. This invention is made from two single pieces of metal with drilled piston holes, said piston holes containing pistons that control cams grasping the cable, determining the cable movement. The entire guide is controlled with two simple control levers and is self-lubricating.

This invention is low-cost, easy to manufacture and maintain, and is substantially less subject to rust and corrosion because of its design.

### BACKGROUND OF THE INVENTION

This invention relates to the field of home and commercial drain cleaning machinery, in particular mechanisms for advancing and retracting a cable snake drain cleaner.

Typical drain cleaning snakes are portable, electric-motor-driven mechanisms that pass a long articulated cable down a plumbing fixture to and through the sewer line. The intent is to use the sharp blades at the end of the rotating snake cable to slice through roots and other obstructions that periodically clog and stop drain pipes.

There are several previous inventions of a similar nature that provide feed control mechanisms for the snake, notably, U.S. Pat. No. 5,901,401 to Rutkowski and U.S. Pat. Nos. 5,507,062 and 5,239,724 to Salecker. The technology of controlling the direction of the snake cable and changing the motion of the cable by means of a set of rollers and control levers is well known.

The direction control mechanisms of these previous snake feeders are, in general, complex and possess multiple parts and connectors. There is an advantage to minimizing the number of moving parts and control levers to control the snake cable direction, and these earlier inventions make more or less successful attempts to achieve this advantage. The parts disposed in the interior of the cable feeder are regularly exposed to water and sewage, which leads to corrosion and rust. When the corrosion and rust reached a certain level in the feeder, it must be broken down and cleaned, or if that is not possible because of its construction, then it must be replaced. A cable feeder with the minimum number of moving parts and components exposed to the plumbing environment is the preferred implementation.

### BRIEF SUMMARY OF THE INVENTION

The cable feeder of this invention is a simple metallic framework with a minimum of moving parts that provides a centrally disposed opening through which a snake cable passes. This opening is sizeable by means of an adjustment mechanism and possesses a set of three rollers that grip the cable. The rollers are canted in such a fashion that they grip the cable and allow it to advance or reverse depending on a position set by a control lever.

The control lever turns a face plate covering the main body of the invention. The rotating face plate adjusts three cams, one cam per roller, that alters the roller position. This technology is well-known.

The advancement offered by this invention resides in the simplicity of its construction and the reduced number of moving parts. Competing designs of similar cable controllers are fundamentally hollow, flat cylinders that have many moving parts to control the cable direction. The present invention is a single piece main body and a single piece face plate. The main body has circumferential piston holes drilled through from the outer edge that contain the cams and the cams control the rollers through the pistons holes. The guide hole for the cable is sized by means of an adjustment screw, attached to one of the pistons.

### BRIEF DESCRIPTION OF THE DRAWINGS

The construction and operation of the invention can be readily appreciated from inspection of the drawings that accompany this application.

FIG. 1 is a perspective view of the invention.

FIG. 2 is a front cross-section of the invention.

FIG. 3 is cross-section of one of the cams in reverse control position

FIG. 4 is cross-section of one of the cams in neutral control position

FIG. 5 is cross-section of one of the cams in forward control position

FIGS. 6A, 6B, and 6C are an exploded diagram of the invention

### DETAILED SPECIFICATION

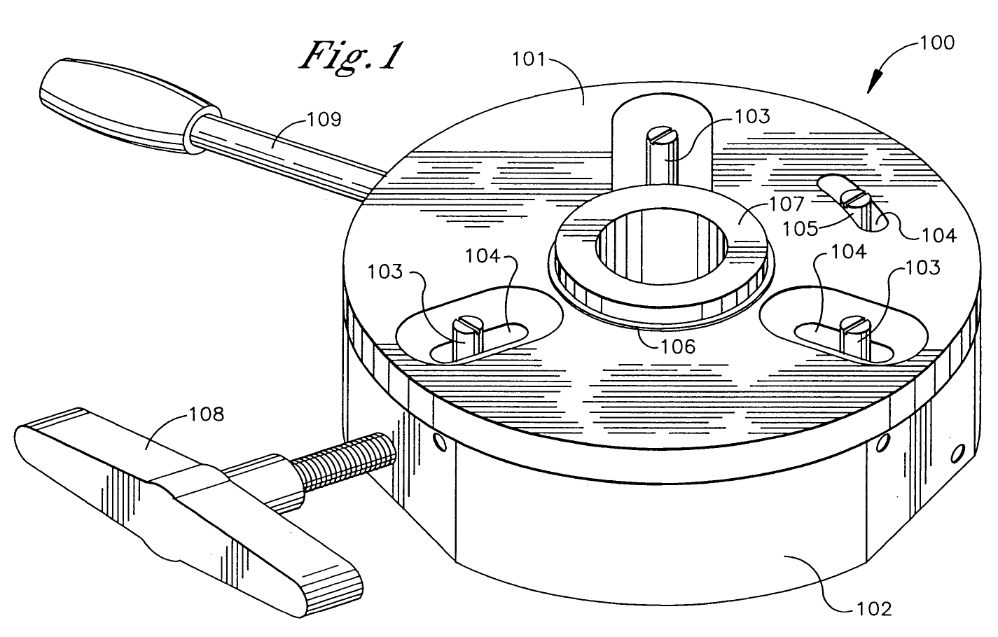

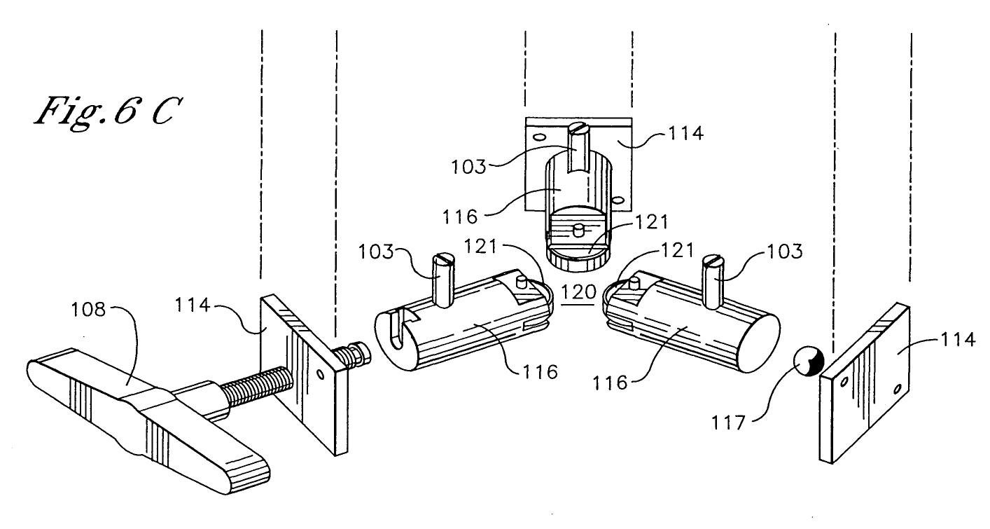

Referring to FIG. 1, The cable guide¹⁰⁰ consists of a circular faceplate¹⁰¹, a main body¹⁰², an adjustment screw handle¹⁰⁸, a control handle¹⁰⁹, a plurality of piston screws¹⁰³, a plurality of piston screw access holes¹⁰⁴ in the faceplate¹⁰¹, a connection screw¹⁰⁵, a lock ring¹⁰⁶, and a cable guide hole¹⁰⁷. Referring to FIGS. 6A, 6B, and 6C, the internal workings of the invention are revealed. In FIG. 6B, the piston holes¹¹⁰, cable guide hole¹¹¹, piston hole plate settings¹¹², cam screw holes¹¹³, and connection screw¹⁰⁵ are shown.

In FIG. 6C, the arrangement of the pistons¹¹⁶ can be seen. One piston¹¹⁶ has an adjustment screw handle¹⁰⁸ inserted through the piston faceplate¹¹⁴ and removably inserted into the top of the piston¹¹⁶, the faceplate¹¹⁴ removably attached to the main body¹⁰². The remaining pistons¹¹⁶ have a piston faceplate¹¹⁴ removably attached to the main body¹⁰², but with a ball bearing recess¹¹⁵ in the main body under the piston faceplate¹¹⁴. Between the piston faceplate¹¹⁴ and the top of the piston¹¹⁶ is a spherical ball bearing¹¹⁷ that helps the circular faceplate¹⁰¹ turn when the control handle¹⁰⁹ is grasped and the circular faceplate¹⁰¹ is turned around the cable guide hole¹⁰⁷. This assembly prevents an air-tight seal and also prevents the piston assembly from drying out and becoming unlubricated.

At each piston central end¹²⁰ are cable guide cams¹²¹ that engage the cable. The manner in which the cable guide cams¹²¹ engage the cable is adjusted by the turning of the pistons¹¹⁶ by means of rotating the circular faceplate¹⁰¹ around the cable guide hole¹⁰⁷. As the circular faceplate¹⁰¹ is rotated, the three piston screws¹⁰³ attached fixedly to the pistons¹¹⁶ move slightly left or right to the ends of the travel afforded by the cam screw access holes¹¹³.

At one end of the travel, each piston¹¹⁶ is rotated such that the cable guide cams¹²¹ engage the cable in such a manner that the cable can advance through the cable guide hole¹⁰⁷. At the other end of the travel, the cams¹²¹ are positioned by the pistons¹¹⁶ to enable the cable to only be reversed in direction.

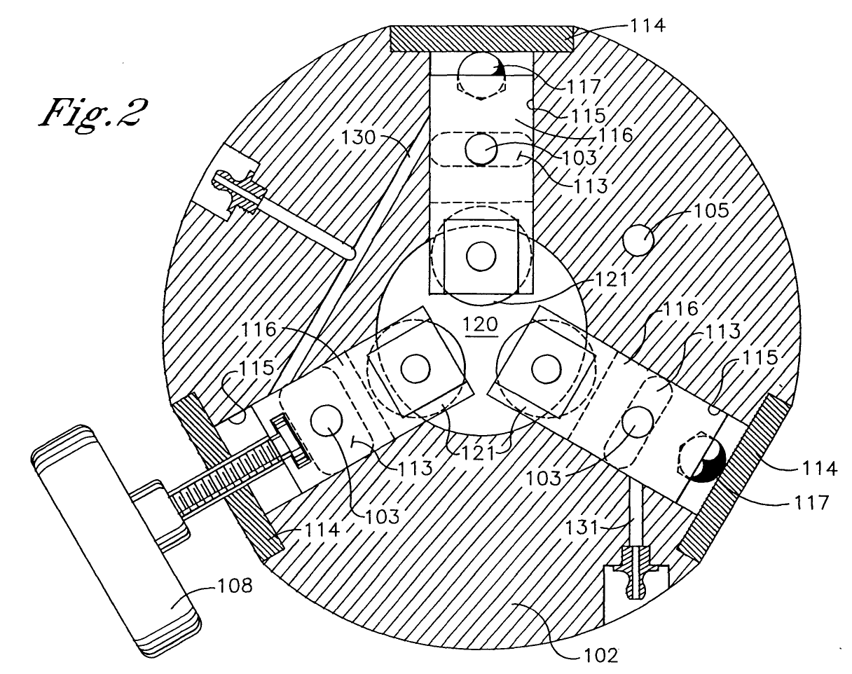

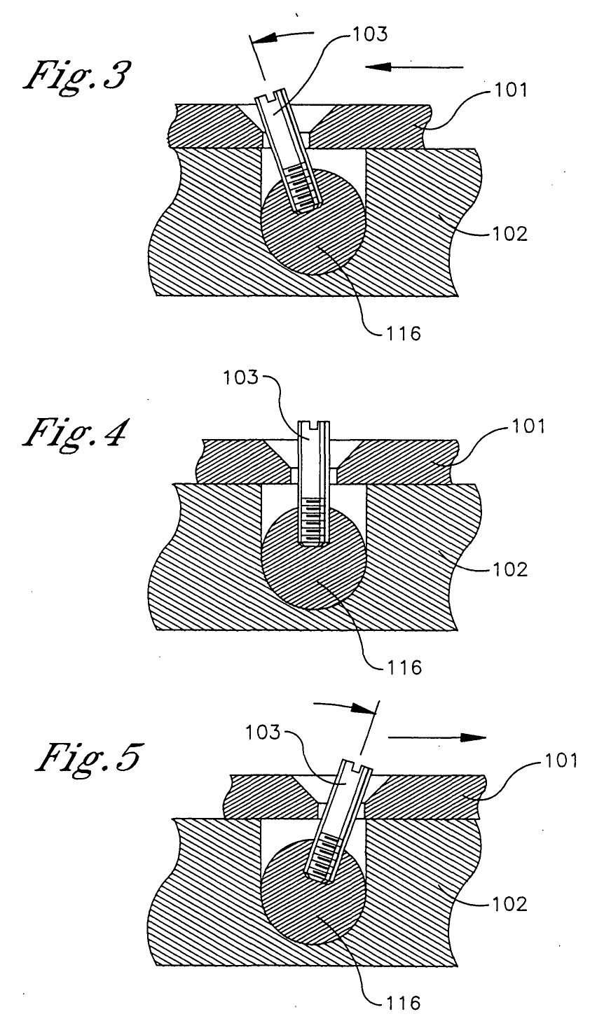

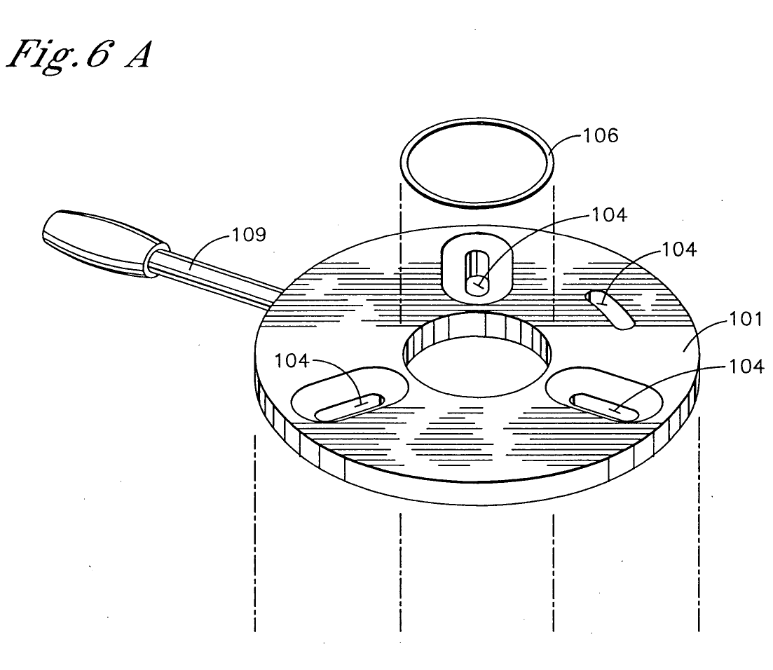

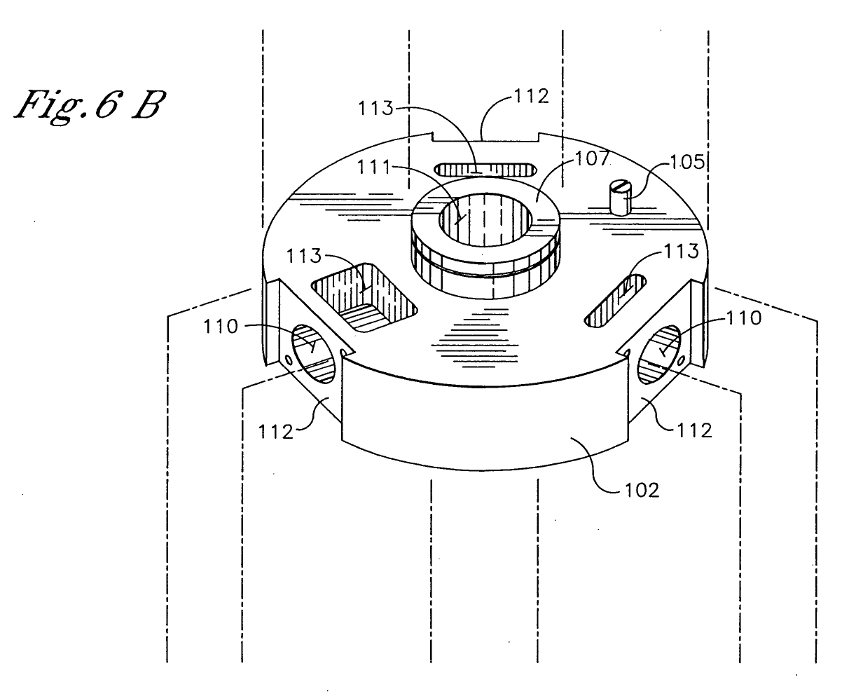

In FIG. 2, the entire mechanism is seen in cross-section. Shown in this figure is the transverse grease fitting¹³⁰ and the circumferential grease fittingly, These fittings are used to lubricate the invention. FIG. 3, 4, and 5 show how the rotation of the circular face plate¹⁰¹ moves the piston screws¹⁰³ within the cam screw holes¹¹³ such that the pistons¹¹⁶ rotate in the desired direction. In FIG. 3, the mechanism supports reverse movement of the cable, in FIG. 4 the mechanism is in neutral position, and in FIG. 5 the cable will move in the forward direction.

While the foregoing describes a preferred embodiment, variation on this design and equivalent designs may be resorted to in the scope and spirit of the claimed invention.

What is claimed is:

1. A plumbing cable guide,
the cable guide comprised of a main body and a face plate, the main body in the shape of a flattened cylinder, the face plate in the shape of a flattened cylinder,
the face plate attached removably to the main body by means of a lock ring, the face plate and main body each possessing a cable guide hole, the face plate attached to the main body in such a manner that the cable guide hole of the face plate and the cable guide hole of the main body lie over each other,
the face plate capable of rotating around the central hole of the main body, the face plate possessing a control handle fixedly attached to the circumference of the face plate,
The face plate possessing a plurality of piston screw access holes, the piston screw access holes in the shape of an elongated oval, the main axis of the oval shape aligned with the radius of the circular faceplate,
the main body possessing a plurality of piston holes, each of the piston holes cut through the main body from circumference to the cable guide hole of the main body, each piston hole containing a piston inserted removably into the piston hole,
each piston possessing a piston screw removably attached to the piston, each piston screw positioned such that it protrudes through a cam screw hole cut in the flat surface of the main body, each cam screw hole connecting the surface of the main body with a piston hole, each cam screw hole in the shape of an elongated oval, the long axis of the oval shape of the cam screw hole perpendicular to the radius of the main body,
The piston screw holes of the face plate and the cam screw holes of the main body positioned such that one piston screw hole is placed over one cam screw hole when the face plate and the main body are connected to each other, the piston screw for each piston protruding through the cam screw hole and through the corresponding piston screw hole,
each piston capable of being rotated around its long axis within the piston hole by means of grasping a control handle fixedly attached to the face plate circumference and turning the face plate around the guide hole until the piston screws reach the end of the cam screw holes, the motion of the piston screws forcing each piston to turn around its long axis within the piston hole,
each piston possessing a central end near the cable guide hole, the central end of each piston possessing cams fixedly attached to the piston, the cams configured such that they will grasp a standard plumbers snake cable, the direction of motion of the plumbers snake cable through the cable guide hole controlled by the orientation of the cams on each piston, the orientation of the cams on each piston controlled by the rotational orientation of the piston,
an adjustment screw handle inserted through the circumference of the main body and connected removably to a piston, the adjustment screw handle threaded in such a manner that rotating the adjustment screw handle moves the piston connected to the adjustment screw handle away from the circumference of the main body and towards the cable guide hole of the main body,
the plumbing cable guide used by means of inserting a plumbers snake cable through the cable guide hole of the face plate and through the cable guide hole of the main body, grasping the adjustment screw handle and rotating it until the cam ends of the pistons encounter the surface of the plumbers snake cable, grasping the control handle and rotating the face plate until the cams are set to allow movement of the plumbers snake cable in the desired direction through the plumbing cable guide.
